(19) United States
(12) Patent Application Publication
(10) Pub. No.: US 2017/0366109 A1
(43) Pub. Date: Dec. 21, 2017

(54) SIMULATION OF GRAVITY AND DEVICE FOR GENERATING A FORCE ACTING ON AN OBJECT

(71) Applicant: Airbus DS GmbH, Taufkirchen (DE)

(72) Inventors: Giovanni ORLANDO, Bremen (DE); Jean-Dominique COSTE, Bremen (DE)

(21) Appl. No.: 15/626,800

(22) Filed: Jun. 19, 2017

(30) Foreign Application Priority Data
Jun. 21, 2016 (DE) 102016111346.8

(51) Int. Cl. H02N 15/00; B64G 1/46; B64G 1/40; B64G 1/12; H01F 6/06; H01F 7/02; H01F 7/06

(52) U.S. Cl. CPC H02N 15/00; B64G 1/402; B64G 1/46; B64G 1/12; H01F 7/0236; H01F 7/06; H01F 6/06

(57) ABSTRACT

A method is used for simulating a gravity acting on an object in space. The method comprises inducing a magnetic moment in the object via generation of an external magnetic field in an environment of the object. A device is used for generating a force acting on an object. The device comprises a magnetic device for generating an external magnetic field in an environment of the object and therefore for inducing a magnetic moment in the object. The magnetic device has at least two elements, which can be moved relative to one another for setting the external magnetic field.

### CROSS-REFERENCES TO RELATED APPLICATIONS

This application claims the benefit of the German patent application No. 10 2016 111 346.8 filed on Jun. 21, 2016, the entire disclosures of which are incorporated herein by way of reference.

### BACKGROUND OF THE INVENTION

The invention relates to a method for simulating a gravity acting on an object in space and a device for generating force acting on an object.

The artificial generation of a force acting in a contact-free manner on an object is of interest for a wide range of fields of application. In particular, the absence of gravity in space is problematic for a multiplicity of operations. Simulating gravity is currently only possible to a very limited extent or with great outlay, particularly by generating a rotation and utilizing the centrifugal force resulting therefrom.

### SUMMARY OF THE INVENTION

In order to eliminate at least some of these drawbacks, the invention provides a spray head in which the components to be mixed are kept separated before they arrive at a mixing element in the spray head.

In an embodiment, the invention provides a device for mixing at least two separate streams of components which, when mixed, form a combined fluid stream. The device comprises a conduit with at least two separate passageways defined by passageway walls, each passageway communicating with a separate component stream and arranged to direct the separate component stream in a downstream direction towards exit openings of the passageways in an end face of the conduit, the exit openings each having a predetermined cross-sectional flow area. A separator element is engaged with the end face of the conduit. The separator element has a separate channel communicating with each passageway. A mixing chamber communicates with all of the separator element channels, the mixing chamber being arranged to receive each of the component streams at an upstream end thereof and to permit a mixing of the component streams. An outlet is arranged downstream of the mixing chamber through which the combined fluid stream is dispensed.

The present invention has the object in particular of developing an alternative technology, using which it is possible to simulate gravity in space.

Conversely, a force generated using such a technology can preferably be directed against gravity when used on the Earth. Thus, an object can, for example, be caused to float and/or accelerated in a friction-free or at least low-friction manner.

To effect floating of this type on the Earth, it is known inter alia (cf., e.g., M. V. Berry and A. K. Geim: “Of flying frogs and levitrons” in Eur. J. Phys. 18 (1997), pages 307-313), to utilize magnetic fields, specifically even in the case of non-ferromagnetic objects: So, the gravity can be compensated for diamagnetic objects inside corresponding magnetic fields, in particular, and the objects can thus be caused to float. However, the devices conventionally used for this offer little flexibility in terms of their use, particularly in relation to a range of different or even different types of objects which can be caused to float using the same.

It is therefore a further object of the present invention to provide an improved device for bringing about the floating of objects.

A method according to the invention is used for simulating a gravity acting on an object in space. The method comprises inducing a magnetic moment in the object by means of generation (carried out in space) of an external magnetic field in an environment of the object.

The object can be diamagnetic or paramagnetic in this case. The object is preferably located in a provided position.

According to the invention, the force resulting from the induced magnetic moment is therefore used for simulating the gravity. As a result, the object can also, for example, be fixed or moved in a provided direction in a simple manner in space, or, if the object is a living organism, the object can implement biological processes (e.g., growth) under conditions similar to those on Earth.

As can be seen, the magnetic moment m(x,y,z) induced in the object at a point (x,y,z) and further the magnetic susceptibility x of the object, the volume V of the object and the magnetic field constant (or the magnetic permeability of the vacuum) μ0 can be determined from the generated magnetic field (or the magnetic flux density thereof) ′B(x,y,z).

For example, for diamagnetic materials (which have a magnetic susceptibility χ<0), where B(x,y,z):=|′B(x,y,z)|, in weightless conditions, the force is

$$F = \frac{χ \cdot V}{{μ}_{0}} B ∇ B .$$

If the magnetic field is (substantially) homogeneous or rotationally symmetrical at least in a part region, then the force F is directed parallel to the axis of symmetry of the magnetic field. In the case of a suitably chosen coordinate system, one axis of which (which is here termed the z-coordinate) runs along this axis of symmetry, the corresponding z-component of F along this axis is given by the equation

$$F ( z ) = \frac{χ \cdot V}{{μ}_{0}} B ( z ) {B}^{′} ( z ) ;$$

in this case, z is a point on the axis of symmetry of the magnetic field, B(z):=|′B(0,0,z)|=B(0,0,z) is the strength of the magnetic field in z, B′(z) is the associated derivative and V is the volume of the object. The acceleration α is determined therefrom for

$$a = \frac{χ}{ρ {μ}_{0}} B ( z ) {B}^{′} ( z ) ,$$

where ρ denotes the density of the object; for further details, reference is made to the above-mentioned article of M. V. Berry and A. K. Geim.

According to an advantageous embodiment, a method according to the invention comprises determining a value (or amount) or a value range for a gravity acting on the (diamagnetic or non-diamagnetic) object, which is to be simulated, (or determining a target value or value range for an acceleration α). Preferably, the method furthermore comprises determining at least one parameter value influencing the external magnetic field, using which the determined value or value range can be realized, and checking the at least one parameter value.

Thus, a simulated gravity provided or suitable for a specific case can be realized. In particular, a respectively suitable value or value range for the simulated acceleration due to gravity can be chosen and realized.

The at least one parameter value can, for example, determine a position and/or a spacing of elements in a magnetic device, which can be used for generating the external magnetic field, and/or—if a magnetic device that is used comprises an electromagnet—a voltage to be applied.

The determination of the at least one parameter value preferably takes place in an object-specific manner, taking account of the volume V and/or material of the (respective) object (e.g., the density ρ of the material thereof and/or the magnetic susceptibility χ thereof). In this case, the at least one parameter value preferably influences the magnetic field and therefore the product B∇B or (in the case of a homogeneous or rotationally symmetrical magnetic field) the product B(z)B′(z). It is advantageously determined in such a manner that the force (for example in the above formulas, the product

$$\frac{χ \cdot V}{{μ}_{0}} B ∇ B or \frac{χ \cdot V}{{μ}_{0}} B ( z ) {B}^{′} ( z ) )$$

or the acceleration resulting therefrom in each case takes on the determined value or value range.

In particular, an expansion range inside the external magnetic field can be determined, in which a determined minimum value (as lower limit of a determined value range) of the simulated gravity can then be realized: Thus, for example with the above formula, a variable range for z can be determined, in which the determined value range is achieved.

By checking the at least one parameter value, it is ensured that the at least one parameter is set in such a manner on a magnetic device used for generating the external magnetic field, that the determined value or value range for the simulated gravity is achieved. The checking can comprise a comparison with at least one set parameter value (e.g., for a different object or a different determined value or value range). If this at least one set parameter value deviates from the respective (at least one) determined parameter value, a respective setting can preferably be changed.

Thus, the method may enable a simulation of gravity of different strength and/or for various (diamagnetic or non-diamagnetic) objects.

According to an advantageous embodiment of a method according to the invention, the external magnetic field is generated by means of a device according to the invention according to an embodiment disclosed in this publication.

A device according to the invention is used for generating a force acting on an object (e.g., a simulated gravity of the object in space). The device comprises at least one magnetic device, which has at least two elements, which can be moved relative to one another, and is set up to generate an external magnetic field (i.e., a magnetic field located in an environment of the object) and thus to induce a magnetic moment in the object; this moment causes the force acting on the object in this case. The external magnetic field can preferably be manipulated, for example with regards to the strength and/or direction thereof, by means of a suitable positioning of the elements relative to one another. In particular, by means of an appropriate positioning, a course of the field lines describing the magnetic field can preferably be influenced and/or at least one parameter value can preferably be influenced as outlined above. An embodiment is preferred, in which the generated magnetic field is formed (substantially) rotationally symmetrically or homogeneously at least in one part region. Particularly advantageous is an exemplary embodiment in which the at least two elements are formed rotationally symmetrically about the same axis and/or are arranged symmetrically to at least one plane.

A device according to the invention therefore allows a magnetic field which is suitable or determined in the respective case and thus the magnetic moment induced in the respective object and therefore the force acting on the object to be effected. In particular, by positioning the elements (and, if appropriate further parameters, such as, for example, a voltage to be applied, if the magnetic device comprises an electromagnet) the function of the magnetic flux density (x, y, z) [symbol] ′B(x, y, z) and therefore also the above-defined product

B(x, y, z)∇B(x, y, z) or B(z)B′(z)

can be influenced. Physical results show that this product (in addition to object-specific properties such as volume, dimensions, shape, density and magnetic susceptibility of the object) decisively determines the force generated at the respective point (x,y,z) in a magnetic center of the magnetic device or—in the case of a rotationally symmetrical magnetic field—the force generated at point z on the axis of symmetry; in this case, a region in which the strength of the magnetic field is maximum or, e.g., deviates by at most 15% or at most 10%, more preferably at most 5%, from the maximum thereof is termed a “magnetic center” in this publication. When using the device on the Earth, the device is preferably aligned in such a manner that the magnetic center (or an axis of symmetry) of the generated magnetic field (which is preferably rotationally symmetrical or homogeneous in at least one part region) runs vertically. In a use of this type on the Earth, in which the object is preferably diamagnetic and which then in particular allows a diamagnetic floating to be effected, for a stability of the force generated, the second partial derivatives of the magnetic flux density must additionally be positive in each case; with the aid of a suitable positioning of the elements relative to one another, this property of the generated external magnetic field can preferably also be achieved in a suitable region for z (in the magnetic center, or—if present—along an axis of symmetry of the magnetic field).

Thus, a device according to the invention offers a flexible field of application for generating a force acting on a respective object. The object can preferably be diamagnetic or paramagnetic.

The at least two elements (which can be moved relative to one another) preferably comprise at least one magnet and/or at least one shielding element for deforming a magnetic field.

The at least two elements can, for example, comprise at least one permanent magnet; these are particularly simple to handle and in particular suitable in cases in which a force to be generated can be relative small, for example for objects from the field of microfluidics and/or when using the device for simulating a gravity in space.

At least one of the elements which can be moved relative to one another can be a coil, through which a current flows, that is to say an electromagnet. Magnets of this type can be controlled particularly well.

The at least two elements can comprise at least one superconducting magnet; superconducting magnets of this type are particularly suitable for generating particularly strong magnetic fields.

Alternatively or additionally, the at least two elements can comprise at least one (e.g., water-cooled) Bitter magnet and/or at least one hybrid magnet; using these, particularly large values can be achieved for |B(x, y, z)∇B(x, y, z)| or for |B(z)B′(z)|, they are therefore particularly suitable for larger objects and/or objects which may comprise copper, silicon carbide, carbon or nitrogen oxide.

In a design variant of a device according to the invention, the device comprises at least one quadrupole magnet; this embodiment has the advantage that the profile of the magnetic field to be generated therewith is particularly uniform and predictably focusing.

According to an embodiment, the at least two elements comprise at least one shielding element, at least one ferromagnetic insert element and/or at least one graphite plate. Elements of this type have a large influence on a field profile and therefore on the product B(x, y, z)∇B(x, y, z) or B(z)B′(z) in cooperation with one or more magnetic elements—as a function of the respective spacing. Ferromagnetic insert elements can, for example, comprise an iron ring and/or an iron disc, which can preferably be arranged inside a coil of an electromagnet and coaxially to the coil at a positive distance from one another; the distance may lie, e.g., in a range from 0.5 cm to 2 cm and preferably be changeable. Thus, the value |B(x, y, z)∇B(x, y, z)| or |B(z)B′(z)| can be increased considerably in the region between insert elements of this type with little outlay.

Generating the external magnetic field can, in particular, take place using two, three or more coils of respective electromagnets. The coils are in this case preferably arranged coaxially and can be moved relative to one another in the direction of a common axis (axially displaceable in particular). At least one or at least two of the coils can preferably be superconducting. The coils can have mutually different extents in the axial direction. An embodiment is preferred, in which a first coil (as a first of the elements) is arranged around a second coil (as the second of the elements). The first coil can in this case have a larger or a smaller extent in the axial direction than the second coil.

An embodiment is advantageous, in which the elements which can be moved relative to one another comprise two coaxially arranged coils of electromagnets, of which a first is arranged around the second, and wherein the elements which can be moved relative to one another additionally comprise a third coil of an electromagnet, likewise arranged coaxially with the other two coils. In this case, the third coil is preferably offset with respect to the second coil in the axial direction and can be displaced in the axial direction. A magnetic field, which is or can be generated by one of the coils (preferably the third coil) is in this case advantageously directed counter to a (substantially rotationally symmetrical) magnetic field which is or can be generated by the respectively other coils. A large value |B(z)B′(z)| can be achieved as a result. In particular, a distance of the coils from one another in the axial direction can preferably be chosen and set in such a manner that the value for |B(z)B′(z)| and an advantageous stability range for a respective object and/or a determined value or value range of a force to be generated is achieved.

Suitable values for B(x, y, z)∇B(x, y, z) or for B(z)B′(z) can preferably be chosen in a use-dependent manner by means of a suitable positioning of the at least two elements.

An advantageous design variant of a method according to the invention comprises changing a position relative to one another of at least two elements, which can be moved relative to one another, of a magnetic device that is used (for example changing a distance of the elements from one another). In particular, the object can be a first object and the method can furthermore be a simulation of a gravity acting on a second object, different from the first object, in space. Changing the position of the movable elements relative to one another can in this case take place, for example taking account of the material, the shape and/or at least one dimension of the second object. In particular, this can comprise reading out at least one value suitable for the second object for a distance of the elements from one another from a table or database, in which a plurality of materials, shapes and/or dimensions are preferably assigned to at least one suitable distance in each case, and setting the distance in accordance with the value read out.

According to a special advantageous embodiment of a device according to the invention, which generates a substantially rotationally symmetrical magnetic field in at least one part region, B(z)B′(z)≦−100 T²/m, more preferably B(z)B′(z)≦−450 T²/m, even more preferably B(z)B′(z)≦−1500 T²/m applies for at least one first positioning of the at least two elements relative to one another in at least one part region of a magnetic field which can be generated by the magnetic device (if appropriate with suitable applied voltage).

In the case of use on the Earth in particular, values of this type allow a diamagnetic floating to be effected even for biological substances, living tissue and liquids.

A broad spectrum of values to be set for B(z)B′(z) in this case results in a device which can be used in a particularly flexible manner with regards to the various objects. According to a special exemplary advantageous embodiment of a device according to the invention, which generates a substantially rotationally symmetrical magnetic field in at least one part region, −250 T²/m≦B(z)B′(z), more preferably −100 T ²/m≦B(z)B′(z), even more preferably 0≦B(z)B′(z) applies for at least one second positioning of the at least two elements relative to one another (and if appropriate for a second suitable applied voltage) in at least one part region of a magnetic field which can be generated by the magnetic device. The second positioning can in this case be different from the first or—in the case of a changed applied voltage—match the first.

A device according to the invention can, in particular, be embedded into a test line, which can comprise further stations, e.g., for carrying out further experiments.

To this end, the device can comprise a test chamber, which can be arranged in the center of a magnetic field which can be generated by the magnetic device and into which or out of which the (e.g., diamagnetic) object can be conveyed manually or automatically (e.g., with the aid of a gas or liquid flow).

According to a preferred embodiment, a device according to the invention comprises at least one cooling device. Particularly advantageous is a variant, which additionally comprises a device for checking a temperature of the magnetic device and/or the environment thereof, using which the cooling device can preferably be regulated.

In an advantageous embodiment, a method according to the invention analogously comprises cooling, preferably also additional checking of a temperature of the magnetic device and/or the environment thereof, and also preferably a regulation of the temperature.

One such embodiment having a cooling device or cooling enables a generation of a particularly strong magnetic field or particularly large values for the product B(z)B′(z), so that, e.g., objects with lower magnetic susceptibility (and/or greater mass) can be caused to float or in the sense of a simulated gravity in space, can be accelerated to the desired values. In addition, the cooling can prevent or at least minimize damaging influences of heat on the respective object.

A spacecraft according to the invention, or a space station according to the invention, comprises a device according to the invention according to one of the embodiments disclosed in this publication. Particularly advantageous is a design variant, in which the included device according to the invention for generating force acting on an object comprises a cooling device, as mentioned above, wherein the cooling device preferably has a cold supply from an external environment of the spacecraft or the space station to the magnetic device. The coldness of space can thus be used efficiently for cooling.

A tank according to the invention of a spacecraft comprises a device according to the invention according to an embodiment disclosed in this publication for effecting a force, which acts on a (particularly diamagnetic) fuel contained in the tank; in the sense of the descriptions above, the fuel therefore constitutes the object. The magnetic device is preferably aligned in such a manner that the force mentioned acts in the direction of a tank outlet. The device or the magnetic device can in this case be arranged completely or partly in the interior of the tank space or outside of the same.

Analogously, according to an advantageous embodiment of a method according to the invention, the object is a fuel contained in a tank and the gravity is simulated in the direction of a tank outlet.

### BRIEF DESCRIPTION OF THE DRAWINGS

Preferred exemplary embodiments of the invention are explained in more detail in the following on the basis of drawings. It is understood that individual elements and components can also be combined differently than illustrated. Reference numbers for elements that correspond to one another are used in all of the figures and, if appropriate, are not described anew for each figure.

In the figures:

FIG. 1 schematically shows an exemplary test line having a device for carrying out a method according to the invention;

FIG. 2 schematically shows a device according to the invention according to a first exemplary embodiment;

FIG. 3 schematically shows a device according to the invention according to a second exemplary embodiment; and

FIGS. 4a, 4b schematically show simplified views of two embodiments of a device according to the invention.

### DETAILED DESCRIPTION OF THE PREFERRED EMBODIMENTS

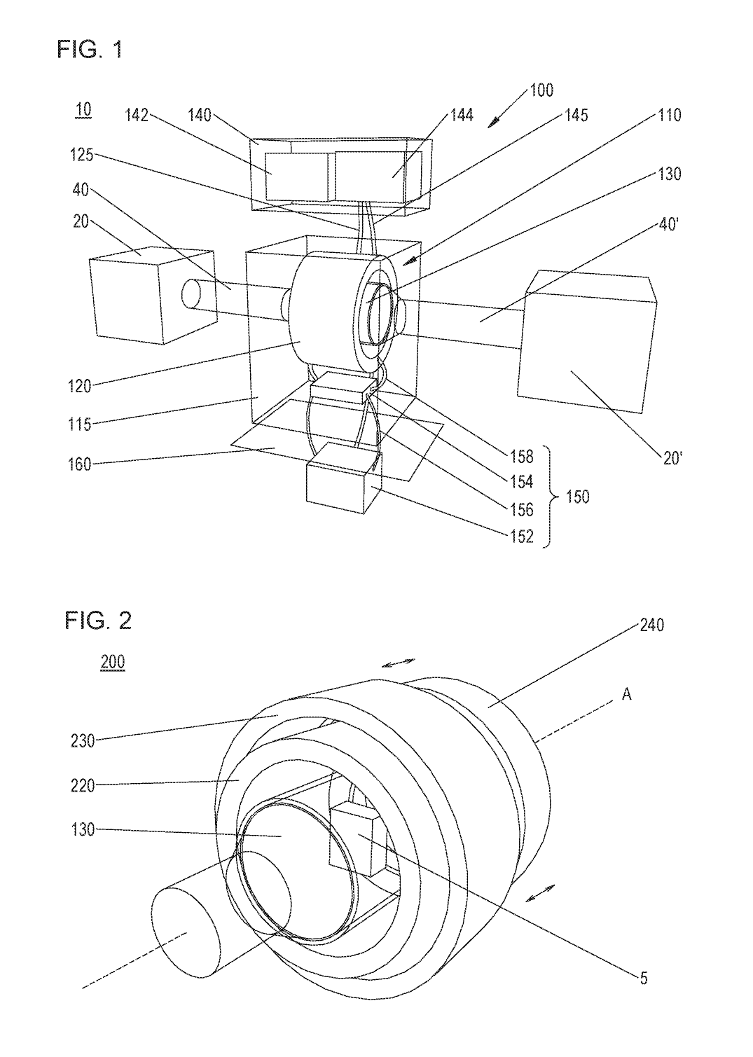

FIG. 1 shows a detail of a test line 10 (simplified, as a functional diagram), which is set up to be used to carry out experiments in a spacecraft or a space station. The test line comprises schematically illustrated testing stations 20, 20′, and—arranged between these testing stations 20, 20′—a device 100 for simulating gravity according to a method according to the invention. The testing stations 20, 20′ are connected to the device 100 (as further station) via an object line 40 or 40′; an object can be transported and thus forwarded (e.g., with the aid of a gas and/or liquid flow) from station to station, where it can be investigated or treated in each case, through the respective object line, which is realized in the illustrated example in the form of a pipe.

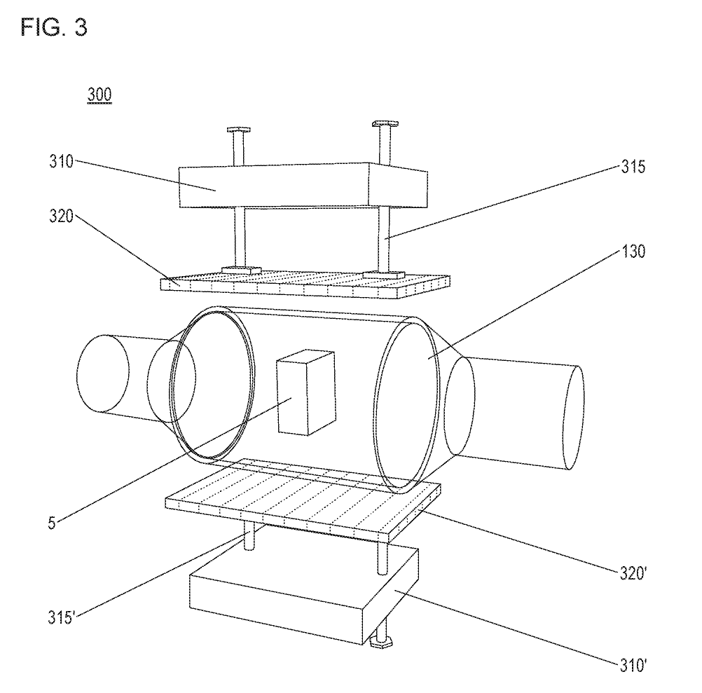

The device 100 comprises a magnetic device 110, which, in the example shown, comprises a single coil 120 as an electromagnet; alternatively or additionally, the device could, for example, comprise at least one further coil arranged coaxially to the coil shown, at least one ferromagnet and/or at least one quadrupole magnet. In particular, the device 100 could, instead of the coil 120, comprise the magnetic device shown in FIG. 2 with the coils 220, 230 and 240 or the magnetic device illustrated in FIG. 3 with the movable magnets 310, 310′ and graphite plates 320, 320′.

A testing chamber 130 is arranged in the magnetic center of the magnetic device 110 (here in the interior of the coil 120), into which or out of which leads to the object line 40, 40′. With the aid of the magnetic device, a gravity on an object in the testing chamber can be simulated in the interior of the testing chamber 130.

The device 100 shown in FIG. 1 further comprises a shielding 115 for electromagnetic radiation, illustrated schematically in the figure, arranged in an environment of the magnetic device 110. This is used to prevent the strong magnetic radiation of the magnetic device from penetrating into other subsystems of the testing line or a spacecraft or a space station, in which the testing line 10 can be arranged, and influencing these subsystems.

The coil 120 is connected by means of at least one cable 125 to an energy source 142 and a control monitoring device 144, which, in the example shown, are contained together in a supply and control device 140; a supply and control device 140 of this type can, in particular, comprise a data memory, in which comparison values can be stored, for example for regulating a temperature and/or for automatically setting a voltage to be applied. If the test line 10 is arranged in a spacecraft or a space station, the energy source 142 can be connected to the energy source thereof (not illustrated). The energy source can preferably be set, particularly it advantageously has an option for manual and/or automated setting of a supply voltage for the electromagnet 120.| In embodiments in which the magnetic device, in addition to the electromagnet 120 shown as first element, comprises a second element (not shown), which is movable relative to the electromagnet, the supply and control device 140 can preferably comprise a moving device for the automatic or manual movement of the elements relative to one another; thus, the properties of the device 100, in particular, can be adapted in a suitable mariner to desired conditions and/or respective objects.

The supply and control device 140 illustrated in FIG. 1 is connected by means of at least one further cable 145 to an external temperature control device 152, which is arranged outside of an outer wall 160 (illustrated in a schematically limited manner), e.g., in an external environment of a spacecraft or a space station and, together with an inner temperature control device 154, is part of a cooling device 150. The external temperature control device 152 is preferably set up to record the temperature of the external environment; the temperature can be conducted via temperature lines 156 to the inner temperature control device 154 and from there via temperature lines 158 to the electromagnet 120, which can thus be cooled quickly and efficiently. The inner temperature control device 154 preferably comprises a measuring device for detecting the temperature of the electromagnet, and the temperature detected in each case is preferably transmitted to the control monitoring device 144, which according to an advantageous embodiment, regulates the cooling by means of the cooling device 150 using the thus-obtained data (e.g., after a comparison with control data from a data memory).

An example of a device 200 according to the invention, for generating a force acting on an object 5, is illustrated in FIG. 2. In the example shown, the object 5 is arranged inside a testing chamber 130, which, analogously to the example shown in FIG. 1, can be connected to object lines 40, 40′. In the case of use in space, the force to be generated using the device can, for example, simulate a gravity acting on the object, in the case of use on the Earth, the force can counteract gravity and thus a floating of the object 5 can be realized; in this case, the device is preferably to be aligned in such a manner that the central axis A of the shown coaxial coils 220, 230, 240 (which are elements of a magnetic device which can be moved relative to one another) runs vertically.

The coils 220, 230, 240 are preferably to be connected or are already connected to at least one energy source, the supply voltage of which can advantageously be set; preferred is an embodiment, in which the respective supply voltage for the individual coils 220, 230, 240 can be set individually.

A current flow can preferably be set in the coil 240 by means of the supply voltage to be applied, which runs counter to a current flow in the coils 220 and 230. In the cylindrical coils 220 and 230 (of which the coil 230 has a smaller axial extent than the coil 220, around which the coil 230 runs) a first external magnetic field can therefore preferably be generated, counter to which a second magnetic field, which can be generated using the coil 240 which is arranged offset to the coils 220, 230 in the axial direction and is likewise cylindrically constructed, is directed. The external magnetic field resulting from overlaying the first and second magnetic fields induces a magnetic moment in the object 5. The force mentioned, which acts on the object, results from this magnetic moment.

As indicated in FIG. 2 by double arrows, the coil 240 is, in this case, preferably movable relative to the coils 220, 230 in the axial direction; alternatively or additionally, the coils 220, 230 arranged around one another can also be movable relative to one another.

Thus, the overlaying of the magnetic fields can be manipulated and for the resultant external magnetic field in particular, the course (and the derivative) of the function B(z) can be changed in direction z along the central axis A; in this case B(z) is in each case the value of the magnetic flux density of the external magnetic field resulting from the overlaying of the individual magnetic fields.

As described above, the force acting on the object 5 and a suitable stability range (in which the object 5 can preferably float in the case of a use on the Earth) can thus be set. According to a specific exemplary embodiment, an axial spacing up to a diameter of the inner coil 220 or further can be set between the coils 220 and 240.

The movement of the coils relative to one another may be possible in a manual and/or automated manner; in particular, the device can comprise a moving device (e.g., an electric motor) (not shown).

A further embodiment of a device 300 according to the invention, for generating a force acting on an object 5, is shown by way of example in FIG. 3. In the example shown, the object 5 is, in turn, arranged inside a testing chamber 130, which, analogously to the example shown in FIG. 1, can be connected to object lines 40, 40′.

The device 300 comprises a magnetic device, which comprises two permanent magnets 310, 310′ with mutually facing faces. Two graphite plates 320, 320′ are arranged between the mutually facing faces, which likewise have mutually facing surfaces; the testing chamber 130 is between these surfaces. The graphite plates are in this case used for a targeted influencing of the magnetic field (which surrounds the object 5 and is therefore “external”).

The mutually facing surfaces of the permanent magnets 310, 310′ and the graphite plates 320, 320′ lie on parallel planes and are movable relative to one another by means of rails 315, 315′. Thus, the spacing between the permanent magnets 310 and 310′, the spacing between the graphite plates 320, 320′ and the spacings between the permanent magnets and graphite plates can be changed; in the terminology used in this publication, in the embodiment illustrated in FIG. 3, the permanent magnets and the graphite plates are therefore the elements which can be moved relative to one another. Thus, the magnetic field and therefore the product B(z)B′(z) can be optimized for the respective object (using its inherent properties). The movement of the elements relative to one another may be possible in a manual and/or automated manner; in particular, the device can comprise a moving device (e.g., an electric motor) (not shown).

In alternative embodiments, a device according to the invention only has exactly one permanent magnet and/or exactly one graphite plate as elements which can be moved relative to one another.

In the case of a use on the Earth, the permanent magnet(s) and the graphite plate(s) are, in each case, preferably arranged above one another in the vertical direction (as illustrated).

A method according to the invention is used for simulating a gravity acting on an object 5 in space. The method comprises generating an external magnetic field in an environment of the object. Thus, a magnetic moment is induced in the object.

A device (200, 300) according to the invention is used for generating a force acting on an object 5. The device comprises a magnetic device for generating an external magnetic field in an environment of the object and therefore for inducing a magnetic moment in the object. The magnetic device has at least two elements 220, 230, 240, 310, 310′, 320, 320′, which can be moved relative to one another for setting the external magnetic field.

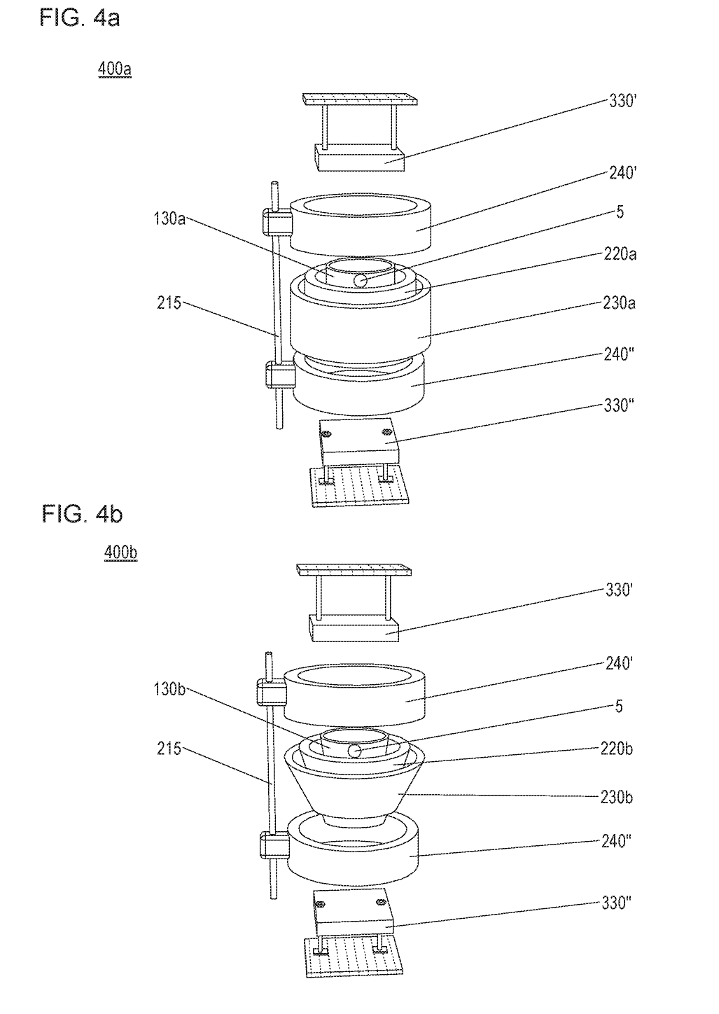

FIGS. 4a and 4b show simplified views of two embodiment of one device 400a or 400b according to the invention in each case: Each of these devices comprises two coils of electromagnets arranged coaxially in one another, which run around a respective testing chamber: In the device 400a shown in FIG. 4a, these coils 220a, 230a running around the testing chamber 130a are constructed, like an outer wall of the testing chamber 130a also, substantially along the enveloping surface of a respective circular cylinder, whereas the corresponding coils 220b, 230b and the outer wall of the testing chamber 130b in the exemplary embodiment 400b shown in FIG. 4b are substantially formed along the enveloping surface of a respective circular cone. The respective common central axis (axis of rotational symmetry) is not drawn in FIGS. 4a, 4b. The respectively internally arranged coil 220a or 220b has a larger axial extent (with respect to this central axis) than the respectively outer coil 230a or 230b.

In the exemplary embodiments shown in FIGS. 4a, 4b, one further coil 240′, 240″ in each case on each side is arranged offset in the axial direction (again with respect to the central axis), the spacing of which coils from one another can be adjusted with the aid of rails 215. One permanent magnet 330′, 330″ in each case is arranged on the outwardly facing side, in the axial direction, of each of the coils 240′, 240″. The permanent magnets 330′, 330″ are preferably likewise movable relative to one another in the axial direction (not illustrated), the spacing thereof from one another (and therefore the space delimited thereby, which comprises the coils and the testing chamber) can therefore be set.

The coils 220a, 230a, 240′ and 240″ (or 220b, 230b, 240′, 240″) are preferably to be connected or are already connected to at least one energy source (not illustrated), the supply voltage of which can advantageously be set; advantageous is an embodiment, in which the respective supply voltage for the individual coils can be set individually.

A current flow can preferably be set in each case in the coils 240′, 240″ by means of the supply voltage to be applied, which runs counter to a current flow in the coils 220a and 230a (or 220b, 230b).

The (external) magnetic field resulting from overlaying the magnetic fields of the coils 220a, 230a, 240′ and 240″ (or 220b, 230b, 240′, 240″) and the permanent magnets induces a magnetic moment in the object 5. The force mentioned, which acts on the object 5, results from this magnetic moment. By means of a setting of the various spacings and/or supply voltage(s), the force can preferably be set up in a suitable fitting manner for the object (for example for the material thereof, the shape thereof and/or the dimensions thereof). In the case of use on the Earth, the object 5 can for example be caused to float in this manner, in the case of use in space, a gravity (of settable strength) acting on the object 5 can be simulated by means of the generation of the force.

While at least one exemplary embodiment of the present invention(s) is disclosed herein, it should be understood that modifications, substitutions and alternatives may be apparent to one of ordinary skill in the art and can be made without departing from the scope of this disclosure. This disclosure is intended to cover any adaptations or variations of the exemplary embodiment(s). In addition, in this disclosure, the terms “comprise” or “comprising” do not exclude other elements or steps, the terms “a” or “one” do not exclude a plural number, and the term “or” means either or both. Furthermore, characteristics or steps which have been described may also be used in combination with other characteristics or steps and in any order unless the disclosure or context suggests otherwise. This disclosure hereby incorporates by reference the complete disclosure of any patent or application from which it claims benefit or priority.

### REFERENCE NUMBERS

5 Object

10 Test line

20, 20′ Testing station

40, 40′ Object line

100 Device for simulating gravity

110 Magnetic device

115 Shielding

120 Coil

125 Cable

130, 130a, 130b Testing chamber

140 Supply and control device

142 Energy source

144 Control monitoring device

145 Cable

150 Cooling device

152 Inner temperature control device

154 Outer temperature control device

156, 158 Temperature lines

160 Outer wall

200, 300, 400a, 400b Device for generating a force acting on an object

215 Rails

220, 220a, 220b, 230,

230a, 230b, 240, 240′, 240″ Coils

310, 310′ Permanent magnet

315, 315′ Rails

320, 320′ Graphite plate

330′, 330″ Permanent magnet

A Central axis

1. A method for simulating a gravity acting on an object in space, comprising:
inducing a magnetic moment in the object via generation of an external magnetic field in an environment of the object.

2. The method according to claim 1, wherein the object comprises a diamagnetic object and which further comprises determining a value or a value range for a gravity acting on the diamagnetic object, which is to be simulated, determining at least one parameter of the external magnetic field, which is suitable for effecting the determined value or value range, and checking the at least one parameter.

3. The method according to claim 1, wherein the external magnetic field is generated via a device, which comprises a magnetic device having at least two elements, wherein the at least two elements are movable relative to one another for manipulating the external magnetic field.

4. The method according to claim 3, further comprising changing a position of the at least two elements relative to one another.

5. The method according to claim 4, wherein the changing a position of the at least two elements relative to one another comprises changing a spacing between the at least two elements.

6. A device for generating force acting on an object, comprising:
a magnetic device configured to generate an external magnetic field and thus for inducing a magnetic moment in the object,
the magnetic device having at least two elements which are movable relative to one another for setting the external magnetic field.

7. The device according to claim 6, wherein the at least two elements comprise at least one of:
at least two coaxially arranged coils of electromagnets;
at least three coaxially arranged coils of electromagnets;
at least one superconducting coil;
at least one permanent magnet;
at least one shielding element;
at least one ferromagnetic insert element;
at least one graphite plate; or
at least one water-cooled Bitter magnet.

8. The device according to claim 6, wherein the magnetic field which can be generated by the magnetic device is substantially rotationally symmetrical or homogeneous in at least one part region.

9. The device according to claim 8, wherein at least one of:
for at least one first positioning of the at least two elements relative to one another in at least one part region of a magnetic field that can be generated by the magnetic device, B(z)B′(z)≦−150 T²/m applies, or
for at least one second positioning of the at least two elements relative to one another in at least one part region of a magnetic field that can be generated by the magnetic device, −250 T²/m≦B(z)B′(z) applies,
in this case, in each case along a central axis (A) of the magnetic field, B(z) is the value of the magnetic flux density at point z, and B′(z) is the associated first derivative of B.

10. The device according to claim 9, wherein B(z)B′(z)≦−450 T²/m.

11. The device according to claim 9, wherein B(z)B′(z)≦−1500 T²/m.

12. The device according to claim 9, wherein −100 T²/m≦B(z)B′(z).

13. The device according to claim 9, wherein 0≦B(z)B′(z);

14. The device according to claim 6, further comprising at least one cooling device.

15. A spacecraft or space station having a device according to claim 6.

16. A tank of a spacecraft, comprising a magnetic device according to claim 6, configured to induce a magnet moment in fuel contained in the tank via generation of an external magnetic field in an environment of the fuel in the tank.
